(19) United States
(12) Patent Application Publication
(10) Pub. No.: US 2017/0087750 A1
(43) Pub. Date: Mar. 30, 2017

(54) FOAM MOULDING POLY(METH)ACRYLIMIDE PARTICLES IN CLOSED MOULDS FOR PRODUCING RIGID FOAM CORES

(71) Applicants: Kay BERNHARD, Darmstadt (DE); Ina LIEBL, Griesheim (DE); Florian BECKER, Darmstadt (DE); Juergen RETTING, Lautertal (DE); Denis HOLLEYN, Hofheim am Taunus (DE); Tim DENK, Grosswallstadt (DE); Alida Suzanne Blanche DONGMO FEUDJIO, Griesheim (DE); Sebastian BUEHLER, Freiburg (DE); Amin KRAATZ, Darmstadt (DE)

(72) Inventors: Kay BERNHARD, Darmstadt (DE); Ina LIEBL, Griesheim (DE); Florian BECKER, Darmstadt (DE); Juergen RETTING, Lautertal (DE); Denis HOLLEYN, Hofheim am Taunus (DE); Tim DENK, Grosswallstadt (DE); Alida Suzanne Blanche DONGMO FEUDJIO, Griesheim (DE); Sebastian BUEHLER, Freiburg (DE); Amin KRAATZ, Darmstadt (DE)

(73) Assignee: EVONIK ROEHM GmbH, Darmstadt (DE)

(21) Appl. No.: 15/312,324

(22) PCT Filed: May 13, 2015
(86) PCT No.: PCT/EP2015/060562

§ 371 Date: Nov. 18, 2016

(30) Foreign Application Priority Data
May 19, 2014 (DE) 10 2014 209 425.9

(51) Int. Cl. B29C 44/44; C08J 9/34; B29C 44/42; B29C 44/34; B29C 44/58

(52) U.S. Cl. CPC B29C 44/445; B29C 44/3415; B29C 44/58; B29C 44/42; C08J 9/34; B29K 2079/08

(57) ABSTRACT

The invention relates to a process for the production of mould-foamed poly(meth)acrylimide (P(M)I) cores, in particular of polymethacrylimide (PMI) cores, which can be used by way of example in automobile construction or aircraft construction. A feature of this process is that polymer granules or polymer powder are charged to a compression mould where they are foamed. A particular feature of the process is that said two-shell compression mould has, respectively on both sides, a cavity that conforms to the shape and which serves for both the heating and the cooling of the granules and, respectively, of the rigid foam core produced therefrom.

### FIELD OF THE INVENTION

The invention relates to a process for the production of mould-foamed poly(meth)acrylimide (P(M)I) cores, in particular of polymethacrylimide (PMI) cores, which can be used by way of example in automobile construction or aircraft construction. A feature of this process is that polymer granules or polymer powder are charged to a compression mould where they are foamed. A particular feature of the process is that said two-shell compression mould has, respectively on both sides, a cavity that conforms to the shape and which serves for both the heating and the cooling of the granules and, respectively, of the rigid foam core produced therefrom.

### PRIOR ART

DE 27 26 260 describes the production of poly(meth)acrylimide foams (P(M)I foams) which have excellent mechanical properties which are also retained at high temperatures. The foams are produced by the casting process, i.e. the monomers and additional substances required are mixed and polymerized in a chamber. In a second step, the polymer is foamed by heating. This process is very complicated and is difficult to automate.

DE 3 630 930 describes another process for the foaming of the abovementioned copolymer sheets made of methacrylic acid and methacrylonitrile. Here, the polymer sheets are foamed with the aid of a microwave field, and this is therefore hereinafter termed the microwave process. A factor that must be taken into account here is that the sheet to be foamed, or at least the surface thereof, must be heated in advance up to or above the softening point of the material. Since under these conditions the material softened by the external heating naturally also begins to foam, it is not possible to control the foaming process solely through the effect of a microwave field: instead, it requires concomitant external control by an ancillary heating system. This means that a microwave field is added to the normal single-stage hot-air process in order to accelerate foaming. However, the microwave process has proved to be too complicated and therefore of no practical relevance and has never been used.

Alongside PMI foams, there are other known foams based on methacrylic acid and acrylonitrile (PI foams) with similar properties. These are described by way of example in CN 100420702C. However, again these foams are produced from sheets.

Alongside these processes which start from an unfoamed polymer sheet, there are also known “in-mould foaming” processes starting from granules. However, in principle these have a number of disadvantages in comparison with the processes described. A non-uniform pore structure is achieved, with differences between the interior of the original particles and the boundaries between the original particles. The density of the foam is moreover inhomogeneous because of non-uniform distribution of the particles during the foaming process—as previously described. Other observations that can be made on these products foamed from granules are poorer cohesion at the interfaces that form between the original particles during the foaming process, and resultant poorer mechanical properties in comparison with materials foamed from a semifinished sheet product.

WO 2013/05947 describes an in-mould process in which at least the latter problem has been solved in that, before the particles are charged to the shaping and foaming mould they are coated with an adhesion promoter, e.g. with a polyamide or with a polymethacrylate. Very good adhesion at the grain boundaries is thus achieved. However, this method does not eliminate the non-uniform pore distribution in the final product.

However, there has to date been very little description of in-mould foaming for rigid foams, in particular for P(M)I foams. In contrast, processes of this type have been known for a long time for other foam materials: the polyurethane foams are produced from an appropriate reactive liquid, mostly at room temperature. Foams made of PE, PP, polystyrene or polylactic acid (PLA) are produced from granules in an in-mould foaming process.

### OBJECT

In the light of the prior art discussed it was therefore an object of the present invention to provide a novel process which can process P(M)I particles with high throughput rate in a simple manner in an in-mould foaming process to give moulded rigid foam cores.

A particular object of the present invention was to provide a process for the in-mould foaming of P(M)I which leads to final products with uniform density distribution and narrow pore size distribution.

A particular object was that this process can be carried out with cycle times that are in particular shorter than those of processes of the prior art, and, without any particular downstream operations, itself leads to rigid foam cores with the final geometry.

Other objects not explicitly discussed at this point can be derived from the prior art, the description, the claims or the inventive examples.

### ACHIEVEMENT OF OBJECT

When the expression poly(meth)acrylimide (P(M)I) is used hereinafter it means polymethacrylimides, polyacrylim ides or a mixture thereof. Similar considerations apply to the corresponding monomers such as (meth)acrylimide and (meth)acrylic acid. By way of example, the expression “(meth)acrylic acid” means not only methacrylic acid but also acrylic acid, and also mixtures of these two.

Said objects are achieved by providing a novel process for the production of rigid poly(meth)acrylimide (P(M)I) foam cores. This process comprises the following steps:
a. Charging of P(M)I particles to a two-shell mould,
b. Heating of the space within the mould and simultaneous foaming of the particles,
c. Cooling of the space within the mould, and
d. Opening and removing the rigid foam core.

A particular feature of this process is that the mould has, in both shells, a cavity which conforms to the internal shape and which covers the area of the respective space within the mould. In step b. a heating liquid is passed through these cavities, and in step c. a cooling liquid is passed through these cavities.

It is preferable that these cavities conform to the shape on the side counterposed to the space within the mould. It is particularly preferable that the external mould side opposite thereto likewise conforms to the shape. It is further preferable that the thickness of the cavities between the two sides thereof is from 2 to 20 cm, preferably from 5 to 12 cm. It is further preferable that the thickness of the mould parts which conform to the shape of the two sides, between the cavity and the space within the mould, is from 2 to 15 cm, preferably from 4 to 12 cm.

It is equally preferable to carry out the process of the invention in such a way that the heating liquid and the cooling liquid are the same type of liquid. In particular here, these liquids are passed from two different reservoirs with different temperatures into the cavity. It is preferable that the temperature of the heating liquid is from 180 to 250° C. and that the temperature of the cooling liquid is from 20 to 40° C.

In particular, oils which do not comprise low-boiling fractions and which resist temperatures up to at least 300° C. are suitable as heating liquid and, respectively, cooling liquid. An example of a suitable oil is SilOil P20.275.50 from Huber.

Before step a., the space within the mould can be equipped with what are known as inserts. These are first surrounded by the granules charged in step a., and are thus entirely or to some extent enclosed by the foam matrix within the subsequent rigid foam core as integral constituent of this workpiece. These inserts can by way of example be items with an internal screw thread. Said internal screw thread can be used subsequently to form screw-thread connections to the rigid foam cores. Analogously it is also possible to incorporate pins, hooks, tubes or the like. During the production of the rigid foam core it is also possible to integrate electronic chips or cables into said core.

In one particular embodiment, these inserts are tubes, blocks or other placeholders which have been coated and shaped in such a way that they can easily be removed from the foam matrix after the removal of the foamed rigid foam core in step d. It is thus possible by way of example to produce cavities, recesses or holes in the rigid foam core.

In the invention there are various preferred embodiments of the P(M)I particles used in step a.

In a first embodiment, the P(M)I particles are ground material derived from a P(M)I sheet polymer obtained in the form of cast polymer. Said sheets can by way of example be comminuted in a mill to give suitable particles. It is preferable in this variant to use ground P(M)I particles of size from 1.0 to 4.0 mm.

In one preferred variant of the invention, said P(M)I particles are prefoamed before these are charged to the mould in step a. Care has to be taken here that the prefoaming is not carried out to completion, but instead is carried out only until the degree of foaming is from 10 to 90%, preferably from 20 to 80%. The final complete foaming then takes place in step b. This variant preferably uses prefoamed P(M)I particles of size from 1.0 to 25.0 mm. It is preferable that the density of these prefoamed P(M)I particles is from 40 to 400 kg/m³, preferably from 50 to 300 kg/m³, particularly preferably from 60 to 220 kg/m³ and with particular preference from 80 to 220 kg/m³. A particularly suitable prefoaming process is defined by way of example in the German Patent Application with application file reference 102013225132.7.

In a third embodiment of the process, the P(M)I particles are P(M)I suspension polymers. It is preferable to use suspension polymers of this type with a size from 0.1 to 1.5 mm. The production of P(M)I suspension polymers can by way of example be found in WO 2014/12477.

In a fourth embodiment of the process of the invention, prefoamed P(M)I suspension polymers are used as initial charge in step a. In relation to the degree of foaming, the statements above relating to the prefoamed particles of a ground material again apply. It is preferable that the density of these prefoamed P(M)I particles is from 40 to 400 kg/m³, preferably from 50 to 300 kg/m³, particularly preferably from 60 to 220 kg/m³ and with particular preference from 80 to 220 kg/m³. The particle size of these prefoamed suspension polymers used is preferably from 0.1 to 1 mm.

It has proved to be particularly preferable that—irrespective of the nature of the particles used—the particles charged in step a. have been preheated to a temperature of from 80 to 180° C. This variant can additionally accelerate the entire process, and surprisingly the overall effect obtained is an even more uniform pore structure in the final product.

In addition or as alternative, suction of the particles into the mould in step a. has proved to be very advantageous and to accelerate the process. It is preferable here that the closed mould is positioned vertically before the particles are charged thereto. The material here is then charged through an appropriate aperture on the upper side of the vertically positioned mould. At the underside, the space within the mould then has a suction device available, connection to which is established in step a., for example by opening a flap that otherwise covers the suction device. The space within the mould also optionally has a plurality of such suction devices available.

It is moreover advantageous that in step a. the mould fill level reached when particles are charged to the mould is from 50 to 100%, preferably from 75 to 98%. In this context, 100% fill level means that the particles are charged to the mould until they reach the uppermost edge thereof. Between the particles here there are naturally unoccupied spaces remaining, the size of which depends on the particle size and the particle shape. Said unoccupied spaces can theoretically constitute up to 50% of the space within the mould, even when the fill level is 100%. Said unoccupied spaces are finally closed by the foaming in step b. and a homogeneous rigid foam core is thus formed.

It is preferable that the foaming in step b. is carried out within a period of at most 5 min. It is equally preferable that the entire process, comprising steps a. to d., is carried out within a period of from 10 to 60 min.

It is preferable in the process of the invention that during the first half, preferably during the first quarter, of the process time of step b. hot air, a hot gas or steam, preferably a hot inert gas or air, is passed into the space within the mould. The temperature of this input is from 90 to 300° C., preferably from 150 to 250° C. The input serves to ensure that the heat uptake of the granules, prior to and during the start of the foaming process, is accelerated and is more uniform.

It is preferable that the cooling liquid that is used in step c. and that is passed out from the cavity is cooled by means of a heat exchanger to the input temperature of from 20 to 40° C. before return to the corresponding reservoir.

In comparison with the prior art, it is possible by means of the process of the invention to produce mouldings or foam materials with a markedly more homogeneous pore structure, and without defects, and at the same time in more complex shapes. This process moreover permits rapid production of these complex shapes within low cycle times and with particularly good quality. In particular, when the process of the invention is compared with prior-art processes it has shorter heating and cooling cycles. Another great advantage of the present process in comparison with the prior art is that it is sufficiently non-aggressive to prevent damage to the surface of the P(M)I particles.

The process of the invention can optionally be integrated into an entire process in such a way that the (prefoamed) P(M)I particles are first provided into a reservoir. The material is then charged from said reservoir to the mould. This variant is clearly particularly useful for entire processes which combine a heating unit for the prefoaming of the particles with a plurality of moulds. The heating unit for the prefoamed process can thus be operated continuously, whereas the shaping moulds naturally operate batchwise with fixed cycle times. It is particularly preferable that the reservoir here is heated and that preheated particles are thus charged to the mould, and that this procedure further reduces the cycle time.

It is moreover possible to use adhesion promoters to improve adhesion between foam core material and outer layers, where said adhesion is significant in subsequent steps for the production of composite materials. Said adhesion promoters can also have been applied on the surface of the P(M)I particles before the prefoaming process of the invention begins, this being an alternative to application in a subsequent step. In particular, polyam ides or poly(meth)acrylates have proved to be suitable as adhesion promoters. However, it is also possible to use low-molecular-weight compounds which are known to the person skilled in the art from the production of composite materials, in particular as required by the matrix material used for the outer layer.

In particular, the process of the invention has the great advantage that it can be carried out very rapidly and therefore in combination with downstream processes with very low cycle times. The process of the invention can therefore be integrated very successfully within a mass production system.

The process parameters to be selected for the entire process of the invention depend on the design of the system used in any individual case, and also on the materials used. They can easily be determined by the person skilled in the art with use of a little preliminary experimentation.

The material used according to the invention is P(M)I, in particular PMI. These P(M)I foams are also termed rigid foams, and feature particular robustness. The P(M)I foams are normally produced in a two-stage process: a) production of a cast polymer, and b) foaming of said cast polymer. In accordance with the prior art, these are then cut or sawn to give the desired shape. An alternative which has not so far become widely accepted in industry is the in-mould foaming process mentioned, and the process of the invention can be used for this.

Production of the P(M)I begins with production of monomer mixtures which comprise (meth)acrylic acid and (meth)acrylonitrile, preferably in a molar ratio of from 2:3 to 3:2 as main constituents. Other comonomers can also be used, examples being esters of acrylic or methacrylic acid, styrene, maleic acid and itaconic acid and anhydrides thereof, and vinylpyrrolidone. However, the proportion of the comonomers here should not be more than 30% by weight. Small quantities of crosslinking monomers can also be used, an example being allyl acrylate. However, the quantities should preferably be at most from 0.05% by weight to 2.0% by weight.

The copolymerization mixture moreover comprises blowing agents which at temperatures of about 150 to 250° C. either decompose or vaporize and thus form a gas phase. The polymerization takes place below this temperature, and the cast polymer therefore comprises a latent blowing agent. The polymerization advantageously takes place in a block mould between two glass plates.

The production of semifinished PMI products of this type is known in principle to the person skilled in the art and can be found by way of example in EP 1 444 293, EP 1 678 244 or WO 2011/138060. Semifinished PMI products that may in particular be mentioned are those marketed in foamed form with the trademark ROHACELL® by Evonik Industries AG. Semifinished acrylimide products (semifinished PI products) can be considered to be analogous to the PMI foams in relation to production and processing. However, semifinished acrylimide products are markedly less preferred than other foam materials for reasons of toxicology.

In a second variant of the process of the invention, the P(M)I particles are suspension polymers which can be introduced directly per se into the process. The production of suspension polymers of this type can be found by way of example in DE 18 17 156 or in the German Patent Application with Application file reference 13155413.1.

A particular feature of the rigid P(M)I foam cores produced according to the invention is that the shape of the rigid foam core is complex, and that a skin of thickness preferably at least 100 μm composed of P(M)I encloses the surface of the rigid foam core to an extent of at least 95%. These novel rigid foam cores therefore have no open pores on the surface and, in contrast to the materials of the prior art, have particular stability, e.g. in relation to shock or impact, even without any additional outer layer. These materials are per se, and therefore irrespective of the process of the invention, novel and are therefore equally provided by the present invention.

It is preferable that the density of these novel rigid P(M)I foam cores is from 25 to 220 kg/m³. These products moreover have optionally been provided with the inserts described above.

The foamed rigid foam cores produced according to the invention, made of P(M)I, can by way of example be further processed to give foam core composite materials. Said foam mouldings or foam core composite materials can in particular be used in mass production by way of example for bodywork construction or for interior cladding in the automobile industry, interior parts in rail vehicle construction or shipbuilding, in the aerospace industry, in mechanical engineering, in the production of sports equipment, in furniture construction or in the design of wind turbines. The rigid foam cores of the invention are generally suitable in principle for any type of lightweight construction.

### INVENTIVE EXAMPLES

PMI granules used comprise a material marketed with trademark ROHACELL® Triple F by Evonik Industries. The granules were produced from a fully polymerized copolymer sheet which had not been prefoamed, by communition with the aid of a granulator. The grain size range of the granules used in the examples, after sieving to remove fines, is from 1.0 to 5.0 mm.

Temperature-control medium used is SilOil P20.275.50 from Huber. The temperature-control medium serves both for the heating and the cooling of the mould.

Data relating to mould used: The internal shell of the mould replicates the geometry of the test sample, and the external shell also conforms to the shape. The respective temperature-control channels in the two mould halves thus ensure provision of temperature control over the entire surface by a system that is close to the outer surface and conforms to the shape. The two shells of the mould halves are sealed against one another by way of a fluororubber gasket.

Data relating to temperature-control equipment used:
dynamic temperature-control equipment for externally enclosed application
Manufacturer Huber (Kältemaschinenbau GmbH)
Name: UNISTAT 530w
cooling power rating 16 kW, heating power rating 12 kW

### Example 1:

### Foaming of a Test Sample Using Granules That Have Not Been Prefoamed

The ground material that had not been prefoamed, from the mill, had an envelope density of about 1200 kg/m³ and a bulk density of about 600 to 700 kg/m³. The quantity of granules required for a test sample with final density 150 kg/m³ is m=103.5 g, inclusive of a proportion of 5% by weight of DYNACOLL® AC1750. The quantity of granules is weighed out and the adhesion promoter is added, and then the mixture is distributed in the mould. The material is charged manually to the cavity in that the granules are distributed uniformly over the entire area in a manner that conforms to the shape. The cavity is then closed, and at this juncture the mould has already been preheated to 140° C. The mould-foaming process follows: here, the mould is heated to 240° C. within a period of 10 minutes. Once 240° C. has been reached, this temperature is maintained for eight minutes. After a total of 18 minutes, the system is switched over to cooling, and the cooling liquid is passed through the mould cavity of the closed mould for 12 minutes. After a total of 30 minutes, the cycle ends and the test sample can be removed.

### Example 2

### Foaming of a Test Sample Using Prefoamed Granules

The granules are first prefoamed so that mould fill level can be maximized. The prefoaming process takes place in an IR oven. The prefoaming process reduces envelope density and bulk density. The residence time, and also the temperature, are varied here. The parameters used here were a temperature of about 180° C. for a residence time of about 2.5 min. This leads to a reduction of bulk density to from 140 to 150 kg/m³. The ground material is distributed onto a conveyor belt by means of a weigh feeder. The conveyor belt brings the granules into a shielded IR source field where the prefoaming process takes place. The material is then discharged. The diameter of the prefoamed particles, in each case at the thickest point, was from 2 to 20 mm.

The quantity of granules required for a test sample with final density 150 kg/m³ is m=103.5 g, inclusive of a proportion of 5% by weight of DYNACOLL® AC1750. The quantity of granules is weighed out and the adhesion promoter is added, and then the mixture is charged by suction conveying into the mould until the fill level reached is almost 100%. To this end, the mould is in an upright position and has already been preheated to 140° C. In the step that follows this, the mould is then brought into foaming position and the mould-foaming process begins. For this, the mould space into which material has been charged is heated to 240° C. within a period of 10 minutes. Once 240° C. has been reached, this temperature is maintained for eight minutes. After a total of 18 minutes, the system is switched over to cooling, and this temperature is maintained for 12 minutes. After a total of 30 minutes, the cycle ends and the test sample can be removed.

1: A process for the production of a rigid poly(meth)acrylimide foam core, the process comprising:
charging poly(meth)acrylimide particles to a mould comprising two shells,
heating a space within the mould and simultaneously foaming the particles,
cooling the space within the mould thereby forming a rigid poly(meth)acrylimide foam core,
opening the mould and removing the rigid poly(meth)acrylimide foam core,
wherein each shell of the mould comprises a cavity which conforms to an internal shape of the mould and which covers the area of the space within the mould, and
wherein a heating liquid is passed through each cavity during the heating and a cooling liquid is passed through each cavity during the cooling.

2: The process according to claim 1, wherein the cavities conform to a shape of the space within the mould and that a thickness of the cavities between a side that conforms to the internal shape of the mould and a side that conforms to the shape of the space within the mould is from 2 to 20 cm.

3: The process according to claim 1, wherein
the heating liquid and the cooling liquid are the same type of liquid, and
the heating liquid and the cooling liquid are passed from two different reservoirs with different temperatures into each cavity, in a manner such that the temperature of the heating liquid is from 180 to 250° C. and the temperature of the cooling liquid is from 20 to 40° C.

4: The process according to claim 1, wherein the poly(meth)acrylimide particles are prefoamed poly(meth)acrylimide particles of size from 1.0 to 25.0 mm.

5: The process according to claim 1, wherein the poly(meth)acrylimide particles are poly(meth)acrylimide suspension polymers of size from 0.1 to 1.0 mm.

6: The process according to claim 1, wherein the foaming is performed within a time period of at most 5 min, and the entire process including the charging, the heating, the foaming, the cooling, the opening, and the removing is performed within a time period of from 10 to 60 min.

7: The process according to claim 2, wherein the thickness of a mould part which conforms to the shape of the side of the cavities that conforms to the internal shape of the mould and the side of the cavities that conforms to the shape of the space within the mould, between the cavity and the space within the mould, is from 2 to 15 cm.

8: The process according to claim 3, wherein the cooling liquid passed out from the cavity after the cooling is cooled by a heat exchanger to the input temperature of from 20 to 40° C. and returned to a corresponding reservoir.

9: The process according to claim 1, wherein the charged poly(meth)acrylimide particles are preheated to a temperature of from 80 to 180° C.

10: The process according to claim 1, wherein during the charging the poly(meth)acrylimide particles are sucked into the mould.

11: The process according to claim 1, wherein the mould fill level reached during the charging of the poly(meth)acrylimide particles to the mould is from 50 to 100%.

12: The process according to claim 1, wherein during a first half of a process time of the heating hot air or steam is passed into the space within the mould.

13: A rigid poly(meth)acrylimide foam core, comprising:
a rigid foam core comprising poly(meth)acrylimide, and
a skin comprising poly(meth)acrylimide which has a thickness of at least 100 μum,
wherein the skin encloses at least 95% of the surface of the rigid foam core, and
the rigid foam core has a complex shape.

14: The rigid poly(meth)acrylimide foam core according to claim 13, wherein the density of the rigid poly(meth)acrylimide foam core is from 25 to 220 kg/m³.

15: The process according to claim 1, wherein the rigid poly(meth)acrylimide foam core has a density of from 25-220 kg/m³.

16: The process according to claim 1, wherein the rigid poly(meth)acrylimide foam core has a uniform density distribution.

17: The process according to claim 1, wherein the rigid poly(meth)acrylimide foam core has a uniform pore structure and a narrow pore size distribution.

18: The process according to claim 1, wherein the rigid poly(meth)acrylimide has no open pores on the surface.

19: The rigid poly(meth)acrylimide foam core according to claim 13 which has no open pores on the surface.

20: The rigid poly(meth)acrylimide foam core according to claim 13 which has at least one selected from the group consisting of a uniform density distribution, a uniform pore structure, and a narrow pore size distribution.
